(19) United States
(12) Patent Application Publication
(10) Pub. No.: US 2004/0001576 A1
(43) Pub. Date: Jan. 1, 2004

(54) Selective answering system

(76) Inventors: Li K. Wang, Norcross, GA (US); Ivy I. Li, Norcross, GA (US)

Correspondence Address: Li K. Wang, 5156 Broadgreen Drive, Norcross, GA, 30092, US

(21) Appl. No.: 10/179,381

(22) Filed: Jun. 26, 2002

(51) Int. Cl. H04M 1/64

(52) U.S. Cl. 379/88.19

(57) ABSTRACT

An apparatus and method for selectively answer incoming calls. The incoming calls are answered differently depending on calling telephone numbers. If an incoming call is from a calling telephone number listed in a non-answer list, then an answering machine according to the present invention will not answer nor record a message for the incoming call.

### FIELD OF THE INVENTION

This invention is related to telecommunications services, and more specifically it relates to apparatus and method for answering incoming calls.

### BACKGROUND OF THE INVENTION

The advent of technologies has made our daily life easier, and now a person can be outside of his home and still not miss calls directed to his home telephone. A telephone answering machine will answer calls, play a pre-recorded message, and record messages from callers. When the person returns his home, he can then play the recorded messages.

Similarly, an entrepreneur can be out of his office and still not missing any incoming facsimiles. A facsimile machine will automatically answer incoming calls, exchange protocols with remote fax machines, and receive incoming facsimiles.

The technology that made all this possible has also created undesired problems. Now it is common for an entrepreneur be swamped with unsolicited fax advertisements. Similarly, an answering machine may answer a telephone call from a relative living in a foreign country, when the caller has no intention to neither leave a message nor pay for a call that is answered by an answering machine.

Accordingly, it would be advantageous to provide a system to selectively answer incoming calls. It is thus to such a system that the present invention is directed.

### SUMMARY OF THE INVENTION

The present invention discloses in a selective answering device having a telephone interface, a controller, a memory, a display, a keypad, a ringing mechanism, and a message recorder. A user may store telephone numbers into the selective answering device, and the device will only answer calls from these telephone numbers.

When an incoming call arrives, the originating telephone number is delivered by Automatic Number Identification (ANI) feature in a telephone switch. The originating telephone number is generally delivered to a destination telephone line between the first ringing tone and the second ringing tone. The telephone interface of the selective answering device receives this information and delivers the originating telephone number to the controller. The controller compares the originating telephone number with stored telephone numbers in the memory. If the originating telephone number matches a telephone number in the memory, the controller activates the ringing mechanism, and the incoming call is answered by the selective answering device. If the originating telephone number is not in the memory, the controller ignores the incoming call, and the incoming call is not answered.

In an alternate embodiment, the user may set the selective answering device in such way that the device will answer calls only if the calls are not originated from the stored telephone numbers.

In yet another embodiment, the user may set different greetings for incoming calls originated from different calling telephone numbers. If an incoming call is originated from a first list of stored telephone numbers, a first greeting is played; if the incoming call is from a origination telephone number listed in a second list of stored telephone numbers, a second greeting is played.

In yet another alternate embodiment, the selective answering device has a facsimile transceiver instead of the message recorder. In this embodiment, the selective answering device will only answer the calls and receive facsimiles from the stored telephone numbers.

In yet another alternate embodiment, the selective answering device only has the telephone interface, the controller, the keypad, the display, the memory, and an outgoing telephone connection. In this embodiment, the selective answering device does not answer the incoming calls. The selective answering device controls whether to pass the ringing tone to the device connected to its outgoing telephone connection.

Other objects, features, and advantages of the present invention will become apparent after review of the hereinafter set forth Brief Description of the Drawings, Detailed Description of the Invention, and Claims appended herewith.

### BRIEF DESCRIPTION OF THE DRAWINGS

FIG. 1 is architecture of a communications network where the present invention is employed.

FIG. 2 is architecture of an exemplary device.

FIG. 3 is block diagram for a programming process.

FIG. 4 is a block diagram for an answering process.

FIG. 5 is a block diagram for an alternative answering process.

FIG. 6 is a block diagram for yet another alternative answering process for a telephone with an intercom feature.

FIG. 7 is a block diagram for yet another alternative answering process with multiple lists.

### DETAILED DESCRIPTION OF THE INVENTION

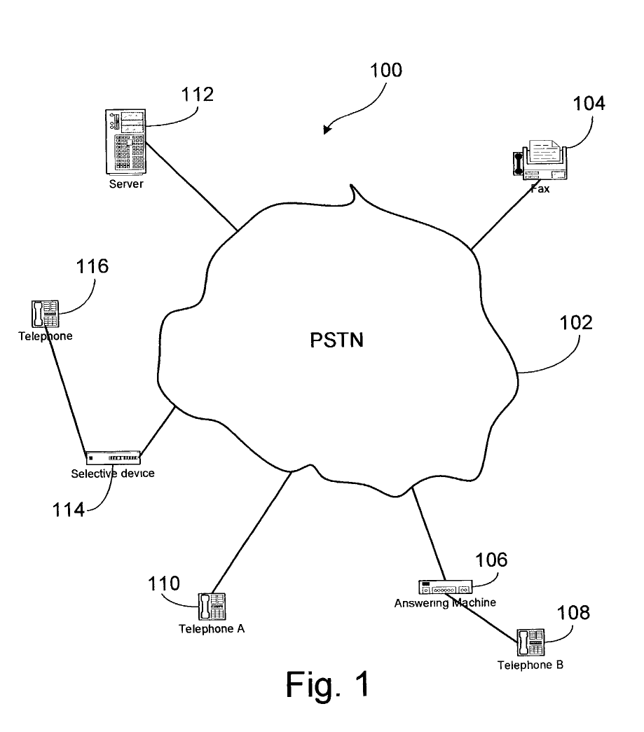

Referring now in more detail to the drawings in which like numerals refer to like elements throughout the several figures, FIG. 1 depicts architecture of a communications network 100 where devices according to the present invention are employed.

The communications network 100 includes a public switched telephone network (PSTN) 102, and different devices connected to the PSTN 102. The devices can be a selective facsimile device 104, a selective answering machine 106 connected to a normal telephone 108, a telephone 110 according to the present invention, a selective device 114 connected to a normal telephone 116, or a server 112.

The selective facsimile device 104, according the present invention, is programmed to receive facsimiles only from telephone numbers listed in an answer list. The selective answering machine 106 can be similarly programmed to only answer and record messages from known calling numbers. The selective answering machine 106 can also be programmed to play different greeting messages to different callers according to their originating telephone numbers.

In an alternative embodiment, the communications network may also include a wireless communications network that serves mobile telecommunications devices.

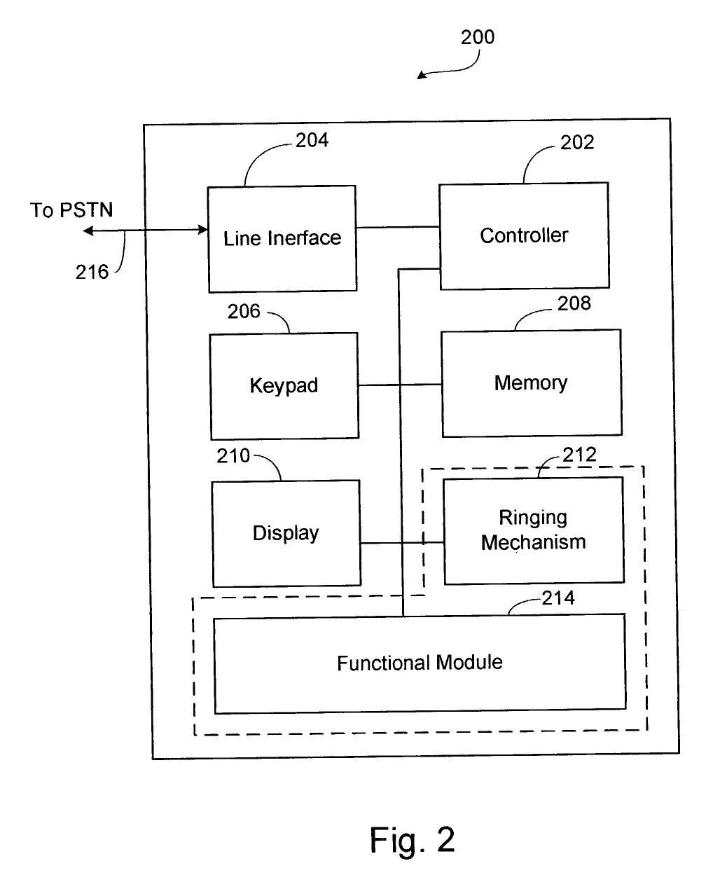

FIG. 2 depicts architecture of a selective answering machine 200 according to the present invention. The selective answering machine 200 is in communication with the PSTN through telephone line 216. The selective answering machine 200 has a controller 202, a line interface 204 for interfacing with the telephone line, a keypad 206 for entering telephone numbers, a memory 208 for storing lists of telephone numbers, an optional display 210 for displaying incoming telephone numbers, a ringing mechanism 212, and a functional module 214. The ringing mechanism 212 can be a ringing mechanism used in conventional telephone devices. The functional module 214 can be an answering and recording mechanism used in conventional answering machines.

The functional module 214 may also be a facsimile receiving mechanism, if the device is a fax machine.

The selective answering machine 200 may optionally include a speaker and a microphone (not shown) when the selective answering machine 200 also acts as a speaker telephone.

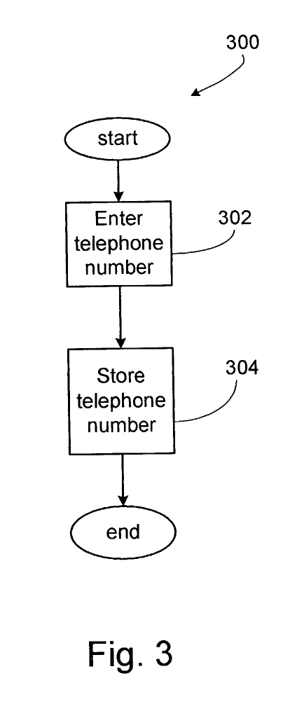

A user can use the keypad 206 to enter a list of telephone numbers (the answer list) that he wants the selective answering machine 200 to answer, and the list is stored in the memory 208. FIG. 3 illustrates a programming process 300 for the selective answering machine 200. The user enters telephone numbers through the keypad 206, block 302, and stores the telephone numbers into a list in the memory 208, block 304.

A user may also use the keypad 206 to create another list of telephone numbers (the non-answer list) that he does not want the selective answering machine 200 to answer.

Optionally, a telephone number can also be entered by retrieving it from a list of received calls. In this case, the user may block future calls originated from the same telephone number who just called him. This makes easier for him to ignore unwelcome telemarketing calls. The user may also select the option of not answering and recording a message if the call is delivered without an identifiable calling telephone number. This helps the selective answering machine 200 to ignore calls from foreign countries, when these calls are most likely delivered without an origination telephone number.

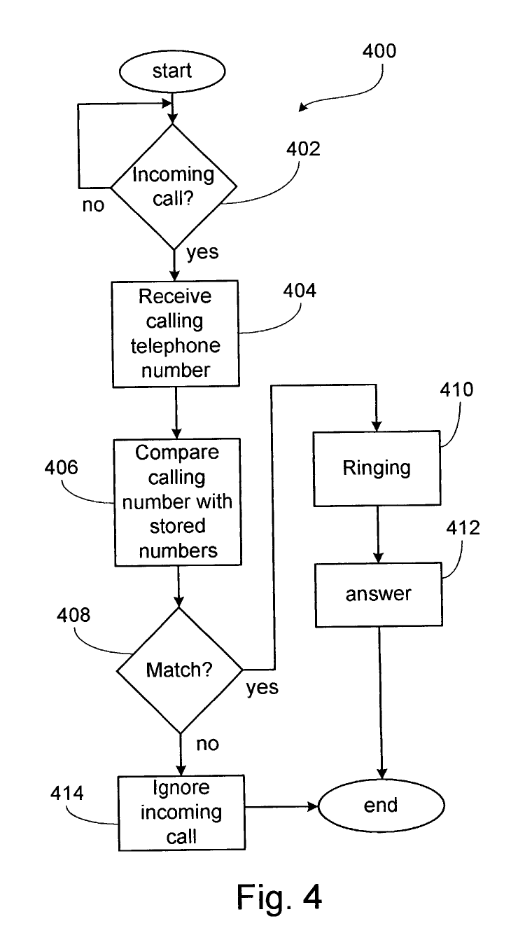

FIG. 4 depicts a block diagram 400 for an answering process for an selective answering machine 200 having an answer list. The selective answering machine 200 monitors incoming calls, block 402. If a call is detected, the selective answering machine 200 receives the calling telephone number delivered by ANI, block 404, and compares the calling number with the answer list stored in the memory 208, block 406. If the calling number matches a telephone number in the answer list, the selective answering machine 200 will ring, block 410, and answer, block 412, according to the user's set up. If the calling number does not match any telephone number in the answer list, the selective answering machine 200 ignores the incoming call, block 414, and the ringing mechanism 212 is not activated.

When the incoming call is ignored, the selective answering machine 200 may display the incoming calling number on the display 210, so the user may receive a record of such call.

Alternatively, when the calling number is not in the answer list, the selective answering machine 200 may ring, but it does not activate the recording function. This will allow the user to be notified about the call, if the user is at home.

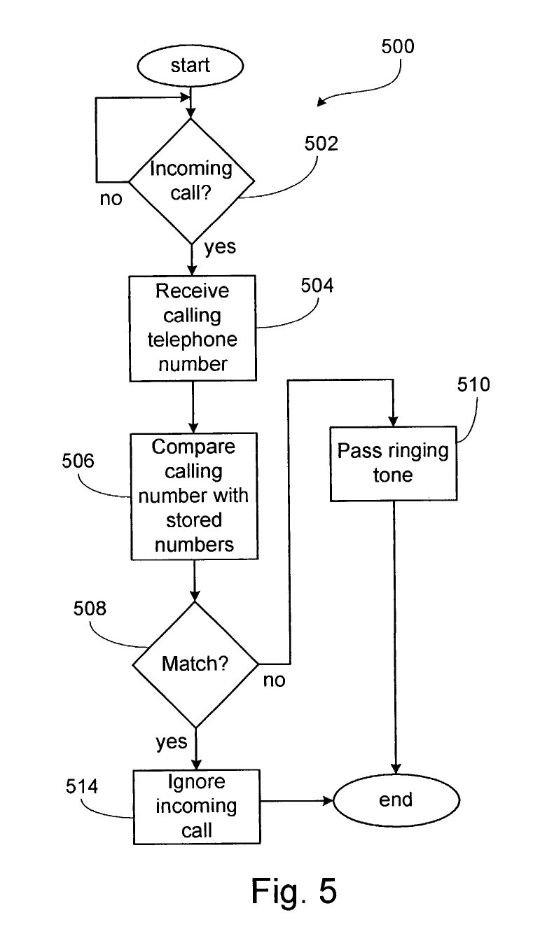

FIG. 5 is a block diagram for an answering process 500 for a selective device 114. The selective device 114 preferably has an incoming connection and an outgoing connection. The incoming connection is connected to an incoming telephone line, and the outgoing connection is connected to a conventional telephone, answering device, fax machine, or other telephonic devices. If the incoming call is from a calling number listed in the answer list, then the incoming connection is bridged with the outgoing connection. If the incoming call is from a calling number not listed in the answer list, then the incoming connection is not bridged with the outgoing connection.

The selective device 114 monitors the incoming connection for incoming calls, block 502. When an incoming call is received, the selective device 114 receives the calling telephone number, block 504, and compares the calling number with a non-answer list, block 506. If the calling telephone number matches a telephone number in the non-answer list, block 508, then the incoming call is ignored, block 514, and the incoming connection is not bridged with the outgoing connection. If the calling telephone number is not listed in the non-answer list, then the incoming connection is bridged with the outgoing connection and the ringing tone is passed to the outgoing connection, block 510.

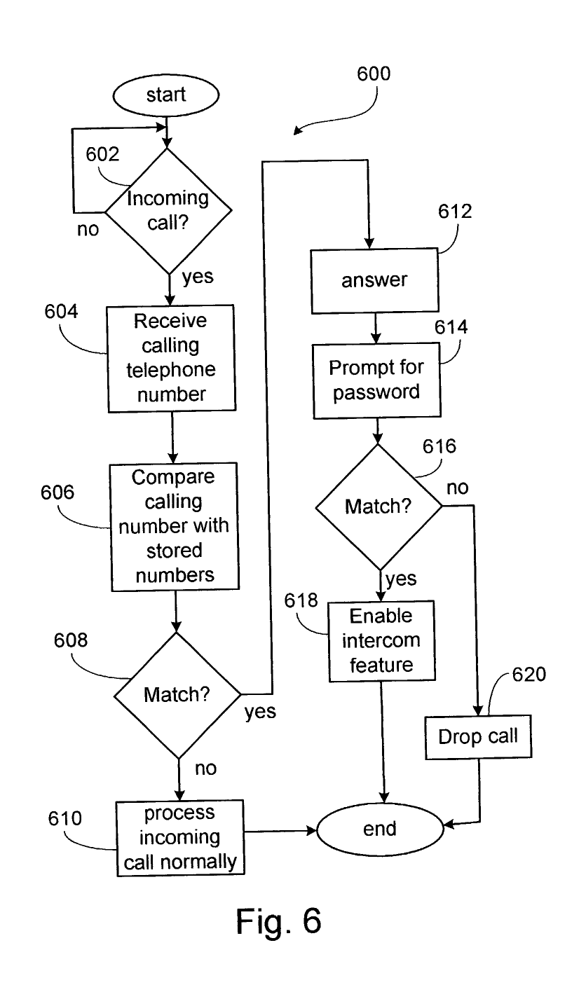

FIG. 6 is a block diagram for an answering process 600 for a monitoring device according to the present invention. The monitoring device is equipped with a speaker and a microphone and allows a special caller to monitor the surrounding where the monitoring device is located. The special caller is a person who calls from designated calling telephone numbers and knows the password.

The monitoring device is connected to a telephone line and monitors incoming calls, block 602. When an incoming call is received, the monitoring device receives the calling telephone number from ANI, block 604, and compares the calling telephone number with a list of stored telephone numbers, block 606. If the calling telephone number is a designated calling telephone number, i.e., the calling telephone number matches a telephone number in the stored telephone number list, the monitoring device answers the call, block 612, and prompts the caller for a password, block 614. If the caller provides the correct password, the monitoring device enables the intercom feature, block 618, i.e., the monitoring device answers the incoming call and enables the speaker and the microphone. The caller can then listen and speak to a person is in the room where the monitoring device is placed even if the person cannot come to the telephone and answer the incoming call. If the caller provides a wrong password, the call is dropped, block 620. If the calling telephone number is not listed as a designated calling telephone number, the incoming call is processed normally, block 610, i.e., and the monitoring device rings normally.

The monitoring device is especially useful for adult children to monitor their aging parents. Often, an adult son calls his father who lives alone, and the call is not answered even when the father is expected to be home. The adult son cannot know whether his father is not home, or his father has collapsed and cannot reach the telephone. By allowing a telephone device to act as an intercom device, the adult son can speak and listen for answer in a remote room. The security and privacy are provided through a list of especially designated calling telephone numbers. The adult son can program his home telephone number, his office telephone number, and his mobile telephone number into this designated calling telephone number list, so only calls from these listed telephone numbers will have access to the intercom feature.

In an alternative embodiment, the monitoring device may allow a caller from any calling telephone to access the intercom feature, if the caller provides the correct password.

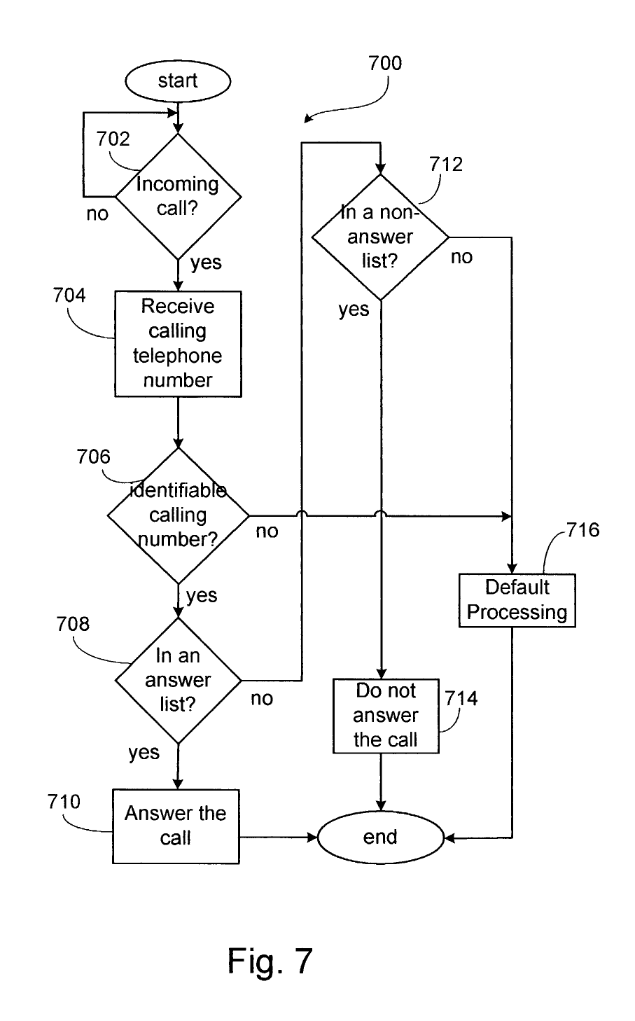

FIG. 7 is a block diagram of yet another alternative answering process 700. The answering process 700 can be implemented in many different devices and among them a fax machine. A fax machine according to the answering process 700 monitors incoming calls, block 702. When a call arrives, the fax machine receives the calling number identification, block 704, and checks whether the information is an identifiable calling number, block 706. The calling number identification is not an identifiable calling number if it is delivered without a calling (origination) telephone number.

The user may set up a default process, block 716, for calls having a non identifiable calling number. The default processing, block 716, may include answering or ignoring the calls, If the device is an answering machine equipped with a clock, the user may choose to answer these calls only within certain time period and ignore them during rest of time.

If the call is delivered with an identifiable calling number, the fax machine checks whether the calling number is in the answer list set up by the user, block 708. If the calling number is in the answer list, the fax machine answer the call, block 710, and the fax machine receives incoming facsimiles.

If the calling number is not in the answer list, the fax machine checks whether the calling number is in the non-answer list, block 712. If the calling number is in the non-answer list, the fax machine does not answer the call, block 714.

If the calling number is an identifiable calling number, but not listed in either the answer list or the non-answer list, the user may specify a default process for it, block 716.

The user can update frequently the answer list and the non-answer list, and thus cutting down on the number of advertisement received through facsimile transmissions.

In yet another alternative embodiment, the present invention may be implemented in a server 112 in communication with the PSTN 102. The telephone service provider may offer a selective voice mail service by using the present invention. A user may subscribe to the selective voice mail service with the service provider.

After subscribing to the service, the user (the subscriber) may place a call to an access telephone number and establish multiple lists. The user may provide different greetings for each list and different answering instructions for each list. For example, for a list having his grandmother's telephone number, he may record a greeting in his grandmother's native language, and for a list having his clients' telephone numbers, he may record a formal greeting that may be updated frequently to give his whereabouts.

When a client calls the user, the call is originated from an origination switch serving the client's telephone and routed to a destination switch serving the user's telephone. The destination switch checks the user's profile and realizes the user is a subscriber of the selective voice mail service. The destination switch then routes the call with the calling telephone number received from the origination switch to the server 112.

The server 112 checks the calling telephone number against the telephone numbers listed in different lists. If the calling telephone number is listed in one of the lists, then the server 112 proceeds according to the instruction established for that list. In this case, when the call is from a client, the server 112 plays a formal greeting previously recorded by the user. The user may create a list especially for this particular caller for a particular purpose. For example, if the user knows the client wants to know the status of his application for a visitor visa, then the user may record a message informing the client about the application status. This special message will then be played when a call is received from the client.

While the invention has been particularly shown and described with reference to preferred embodiments thereof, it will be understood by those skilled in the art that various other changes in form and detail may be made without departing from the spirit and scope of the invention.

What is claimed is:

1. An apparatus for providing services to a selected group of users, wherein each user is identified by a calling telephone number, said apparatus comprising:
a controller;
a incoming telephone line interface connected to said controller, said telephone line interface in communication with an incoming telephone line;
a keypad connected to said controller, said keypad being used for entering telephone numbers;
at least one list of telephone numbers stored in a computer readable memory connected to said controller; and
a functional module connected to said controller for providing services to the selected group of users.

2. The apparatus of claim 1 further comprising a display, wherein said display receives and displays the calling telephone number.

3. The apparatus of claim 1 further comprising a ringing mechanism, wherein said ringing mechanism receives instructions from said controller for ringing if the calling telephone number is listed in at least one list of telephone numbers.

4. The apparatus of claim 1, wherein said functional module provides message recording services.

5. The apparatus of claim 1, wherein said functional module provides facsimile receiving services.

6. The apparatus of claim 1 further comprising an outgoing telephone connection.

7. The apparatus of claim 6, wherein said functional module bridges said incoming telephone line interface with said outgoing telephone connection.

8. A method for providing services to a selected group of users, wherein each user is identified by a calling telephone number, said method comprising the steps of:
establishing at least one list of telephone numbers;
receiving a calling telephone number associated with an incoming call;
comparing said calling telephone number with said at least one list of telephone numbers; and
if said calling telephone number is in said at least one list of telephone numbers, providing a service to said incoming call.

9. The method of claim 8 further comprising the step of displaying said calling telephone number on a display.

10. The method of claim 8, wherein the step of providing a service further comprises the steps of:
answering said incoming call; and
receiving a facsimile transmission from said calling telephone number.

11. The method of claim 8, wherein the step of providing a service further comprises the steps of:
answering said incoming call; and
playing a greeting message associated with said at least one list of telephone numbers.

12. The method of claim 8, wherein the step of providing a service further comprises the steps of:
activating a ringing mechanism; and
if said incoming call is not answered, recording a message from said incoming call.

13. The method of claim 8, wherein the step of providing a service further comprises the step of ignoring said incoming call.

14. The method of claim 8, wherein the step of providing a service further comprises the steps of:
answering said incoming call;
prompting for a password;
receiving a password; and
if said password is correct, enabling an intercom service.

15. A method for providing an intercom service, said method comprising the steps of:
providing a telephone device, said telephone device having a speaker and a microphone;
receiving an incoming call at said telephone device;
prompting for a password to a caller at an originating telephone;
receiving a password from said caller;
checking said password; and
if said password is correct, enabling said speaker and said microphone, so said caller can communicate with a person using said telephone device without said person answering said incoming call.
